(19) United States
(12) Patent Application Publication
(10) Pub. No.: US 2007/0109704 A1
(43) Pub. Date: May 17, 2007

(54) Switching protective device comprising fuses

(76) Inventors: Walter Apfelbacher, Freihung (DE); Klaus Busch, Amberg (DE); Michael Schrock, Ursensollen (DE); Johann Seitz, Amberg (DE)

Correspondence Address: HARNESS, DICKEY & PIERCE, P.L.C., P.O.BOX 8910, RESTON, VA, 20195, US

(21) Appl. No.: 10/565,808

(22) PCT Filed: May 10, 2004
(86) PCT No.: PCT/EP04/04990

§ 371 Date: Jan. 25, 2006

(30) Foreign Application Priority Data
Jul. 25, 2003 (DE) 10334069.6

(51) Int. Cl. H02H 3/08

(52) U.S. Cl. 361/93.1

(57) ABSTRACT

An aim is to make wiring accessories in distribution boards more compact. The aim is achieved by integrating fuses in switching protective devices that are used for functional switching, interrupting, and overload protection such that switching protective devices including fuses can be produced in a housing while short-circuit protection can be coupled to the interruption function if necessary by isolating one fuse from the contact/s.

This application is the national phase under 35 U.S.C. §371 of PCT International Application No. PCT/EP2004/004990 which has an International filing date of May 10, 2004, which designated the United States of America and which claims priority on German Patent Application number DE 103 34 069.6 filed Jul. 25, 2003, the entire contents of which are hereby incorporated herein by reference.

### FIELD

The present invention generally relates to a protective switching device. For example, it relates to one including an operating switching device for switching an appliance to be driven on and off, a disconnection device for disconnection of an input terminal from an output terminal which can be connected to the appliance to be driven, and a protective device for protection of the appliance to be driven against short circuits.

### BACKGROUND

Electronic switching devices, which frequently have silicon thyristors as switching elements, can be subdivided into two types of device: semiconductor contactors and soft starters. Soft starters are used mainly for starting motors and are used for open-loop or closed-loop control of the voltage during starting, by way of phase-gating control. Semiconductor contactors just switch on and off. Semiconductor contactors are often used to switch resistive loads, mainly electrical heaters. For this purpose, so-called multicycle control is frequently used for open-loop or closed-loop temperature control.

Silicon thyristors cannot actively switch off a short circuit. They must therefore be preceded either by circuit breakers or fuses. In this case, the short circuit protection can be provided by coordination type 1 or 2. According to coordination type 1, the switching device is destroyed in the event of a short circuit, and must be completely replaced. According to coordination type 2, the switching device is still fully operable after a short circuit. In this case, the switching device remains intact. With the normal possible short-circuit currents these days (>30 kA), coordination type 2 can be provided only by way of specific semiconductor protective fuses. Short-circuit protection and the disconnector function are normally provided in one unit, which is connected upstream of or downstream from the electronic switching device. Either circuit breakers or fused load disconnectors with fuses are suitable for this purpose.

The power is generally emitted from low-voltage networks via so-called “outgoers”. Each outgoer should have the functions of load switching, overload switching, disconnection, short-circuit protection and overload protection. These functions are typically carried out by a plurality of individual devices. As an exception, a device is known from the Telemecanique, which is switched electromechanically and has the functions of disconnection, short-circuit protection, overload protection and switching during operation. Apart from this, this large number of functions are carried out by at least two devices.

In the case of an outgoer having a fuse and having an electronic switching device without overload protection, an overload relay also has to be attached to the circuit arrangement. In the case of an outgoer with a circuit breaker based on coordination type 2, semiconductor protective fuses must be additionally provided. In both cases, a total of three devices are thus connected in series.

A relatively large amount of physical space is therefore actually required for coordination type 2 outgoers, that is to say in which fuses have to be used. Since the fuse holders and/or fused load disconnectors generally are not matched to the physical width of the electronic switching devices, this results in the space in the cabinet not being used efficiently. This results in high costs for the cabinet and for the space in which the cabinet is installed.

A cabinet for motor control is shown in and known from the document WO 03/056590 A1. A disconnection device, a protective device, an operating switching device and a discharge device are connected in series, for three phases in each case, in this cabinet. The individual devices are designed to be independent of one another, and are electrically connected to one another in the cabinet.

### SUMMARY

An object of at least one embodiment of the present invention is to propose more compact switching devices for switching and protection of electrical loads.

According to at least one embodiment of the invention, an object may be achieved by a protective switching device having an operating switching device. Such a switching device may be for switching a load that has to be driven on and off during operation. A disconnection device is for disconnection of an input terminal from an output terminal which can be connected to the appliance to be driven, and a protective device is for protection against short circuits. Further, the protective device has at least one fuse for disconnection in the event of a short circuit. In addition, the operating switching device, the disconnection device and the protective device are connected in series in each phase, and are integrated in a housing.

The integration of the at least one fuse and the disconnection device with disconnector characteristics in a protective switching device may result in at least one of the following advantages:
This may allow optimum space utilization.
All the components can be matched to one another.
It is possible to achieve a saving in wiring complexity.
The logistic effort may be considerably reduced since only one device need be procured and stored. Without the integration according to at least one embodiment of the invention, fused load disconnectors, fuses and an electronic switching device would have to be handled individually for the same functionality.

The protective switching device according to at least one embodiment of the invention may be in the form of a soft starter, also referred to as a semiconductor motor controller, or a semiconductor contactor. However, it may also be in the form of an electromechanical switching device, for example a contactor.

The at least one fuse can preferably be removed from the housing from the outside, for example for replacement. The at least one fuse preferably includes a semiconductor fuse, which is also referred to as a semiconductor protective fuse. This makes it possible to comply with coordination type 2 for electronic switching points in the event of a short circuit.

The protective device is advantageously arranged between the disconnection device and an output terminal to the appliance to be driven. It is thus possible to replace the fuse from the outside without any voltage applied when the disconnection point is open.

The disconnection device can be combined with the fuse and, when in the open state, can disconnect and release the fuse from at least one contact, for removal. In this case, it is advantageous for the fuse to be arranged in a moving part of the disconnection device. A rotary or slide mechanism can be provided for the moving part of the disconnection device.

The disconnection device may include, for example, two disconnection points. Furthermore, the disconnection device may have the functionality of a fused load disconnector.

The fuses are preferably in the form of cylindrical fuses.

Furthermore, a monitoring device can be provided for recording of tripping of the at least one fuse. The tripping of the fuse can thus be signaled and can be further processed.

In order to reduce the power loss, electronic switching points can be bridged by mechanical contacts (for example a relay or contactor).

Furthermore, an overload device can be integrated in the protective switching device according to at least one embodiment of the invention, in particular with a thermal overload relay, for example with a bimetallic strip or with an electronic overload relay. In this case, current transformers can be used for current measurement. The overload protection can then be provided by the current signal.

The protective switching device according to at least one embodiment of the invention or the entire outgoer circuit can be included in a mounting and wiring system, in which case the complete device can be replaced using plug-in technology. This minimizes the effort required for replacement of a device. However, in this case, it should be possible to plug in the device only in the OFF position. This can be achieved, for example, by way of a mechanical interlock between the fused load disconnector and the “basic mount”, that is to say the device can be replaced only when the fused load disconnector is open.

The outgoer may be a single-pole or 3-pole version. In the case of 3-pole devices, it is also possible to switch only two current paths, that is to say to provide them with switching elements.

### BRIEF DESCRIPTION OF THE DRAWINGS

Embodiments of the invention will now be explained in more detail with reference to the detailed description and the attached drawings, in which:

FIG. 1 shows a circuit diagram of a “closed” load outgoer with an electronic switching point without overload protection;

FIG. 2 shows a circuit diagram of an “open” load outgoer with an electronic switching point without overload protection and with a disconnection point;

FIG. 3 shows a circuit diagram of an “open” load outgoer with an electronic switching point with overload protection and with two disconnection points;

FIG. 4 shows a circuit diagram of an “open” load outgoer with a mechanical switching point with overload protection and with one disconnection point; and

FIG. 5 shows a perspective view of a protective switching device according to at least one embodiment of the invention.

### DETAILED DESCRIPTION OF THE EXAMPLE EMBODIMENTS

The example embodiments which will be explained in more detail in the following text represent preferred example embodiments of the present invention.

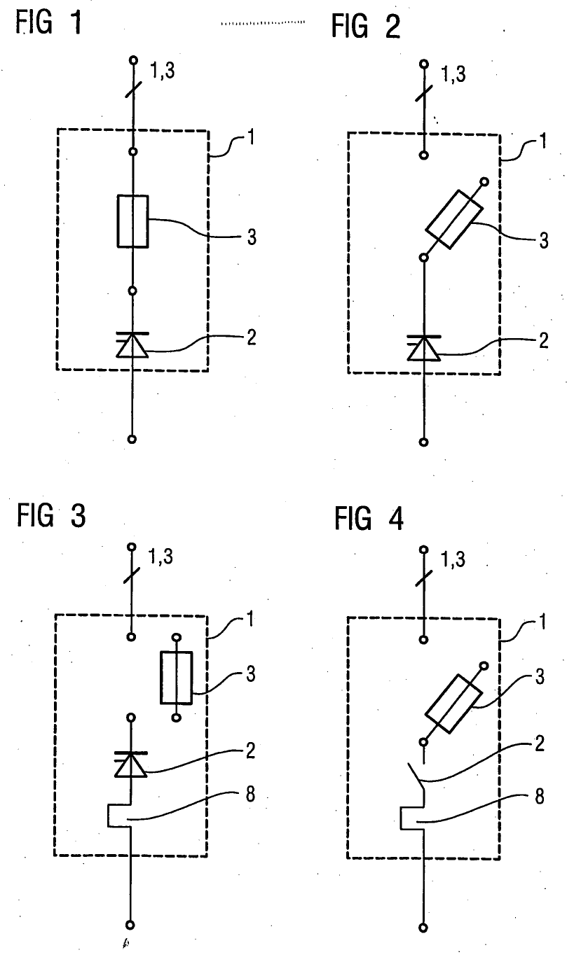

The protective switching device 1 according to at least one embodiment of the invention that is shown in FIG. 1 is used for switching a single-pole or 3-pole line. A 3-pole device including three current paths must be formed in a corresponding manner for a 3-pole line.

In a simplified form, the protective switching device 1 has an electrical switching device 2 and a fuse 3 connected in series with it. In the illustrated circuit, the fuse is shown in the closed circuit on the left-hand side of FIG. 1. The fuse 3 is shown in the open position in FIG. 2. In this position, the circuit (which is not illustrated) from a voltage network to a load is interrupted. If this disconnection results in the required air gaps and creepage distances being complied with, then it is possible to refer to a standardized disconnector characteristic. If both connections of the fuse are disconnected from the circuit, then this results in a double disconnection point. It is thus possible to replace the fuse 3 without any voltage applied, in any case.

FIG. 3 shows a further alternative of a compact protective switching device according to at least one embodiment of the invention. In the illustration, the fuse 3 is disconnected from the current path at two disconnection points. The fuse 3 can thus be removed from the protective switching device 1 with no voltage applied. An overload device for protection against overloading is arranged downstream from the switching device 2, which is also illustrated here as the thyristor, in the protective switching device 1.

A further embodiment of a protective switching device according to at least one embodiment of the present invention is illustrated in FIG. 4. In comparison to the embodiment shown in FIG. 3, only one disconnection point is provided on the fuse 3 in this case. Thus, in some circumstances, the fuse 3 will still be live on removal, that is to say when the load outgoer is open.

In the embodiment shown in FIG. 4, the electronic switching device 2 as shown in FIG. 3 has been replaced by an mechanical switch. This shows that the individual components illustrated in conjunction with FIGS. 1 to 4 can be combined in any desired manner in the protective switching devices.

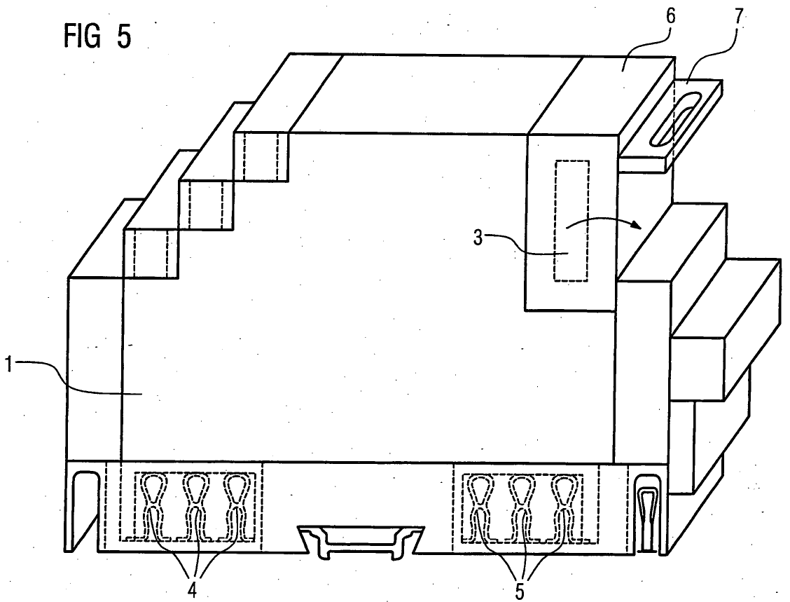

FIG. 5 shows a perspective view of a protective switching device 1 which has input terminals 4 and output terminals 5. The fuse 3 is accommodated in a moving part 6 of the disconnector device. The moving part 6 can be pivoted outward as shown by the arrow via a handle 7. During this tilting movement, the fuse 3 is released from the contacts (not illustrated) on both sides, and can be removed without any voltage applied. This ensures the function of a fused load disconnector.

The protective switching devices according to at least one embodiment of the invention may be used both for building purposes technology and for industrial purposes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A protective switching device comprising:
an operating switching device to switch a load on and off;
a disconnection device for to disconnect an input terminal from an output terminal, connectable to the appliance to be driven; and
a protective device to protect the appliance to be driven against short circuits,
the protective device including a fuse in each phase for disconnection in the event of a short circuit, with the operating switching device, the disconnection device and the protective device being connected in series and being integrated in a housing.

2. The protective switching device as claimed in claim 1, wherein the protective device is in the form of at least one of a semiconductor motor controller, a semiconductor contactor and an electromechanical switching device.

3. The protective switching device as claimed in claim 1, wherein the at least one fuse is removable from the housing.

4. The protective switching device as claimed in claim 1, wherein the at least one fuse is in the form of a semiconductor protective fuse.

5. The protective switching device as claimed in claim 1, wherein the protective device is arranged between the disconnection device and an output terminal to the appliance to be driven.

6. The protective switching device as claimed in claim 1, wherein the disconnection device, when in the open state, disconnects and releases the at least one fuse from at least one contact, for removal.

7. The protective switching device as claimed in claim 1, further comprising at least one of a rotary and slide mechanism for opening and closing the disconnection device.

8. The protective switching device as claimed in claim 1, wherein the at least one fuse is in the form of a cylindrical fuse.

9. The protective switching device as claimed in claim 1, wherein the disconnection device includes the functionality of a fused load disconnector.

10. The protective switching device as claimed in claim 1, wherein the disconnection device includes two disconnection points.

11. The protective switching device as claimed in claim 1, wherein the at least one fuse is arranged in a moving part of the disconnection device.

12. The protective switching device as claimed in claim 1, further comprising a monitoring device for recording of tripping of the at least one fuse.

13. The protective switching device as claimed in claim 1, wherein electronic switching points are bridgeable by mechanical contacts.

14. The protective switching device as claimed in claim 1, further comprising an overload device.

15. The protective switching apparatus as claimed in claim 14, wherein the overload device includes an overload relay.

16. A protective switching device comprising three current paths as claimed in claim 1 for three-pole appliances, wherein at least one of the current paths has no operating switching device.

17. The protective switching device as claimed in claim 2, wherein the at least one fuse is removable from the housing.

18. The protective switching device as claimed in claim 2, wherein the at least one fuse is in the form of a semiconductor protective fuse.

19. A protective switching device comprising:
means for switching a load on and off;
means for disconnecting an input terminal from an output terminal, connectable to the appliance to be driven; and
means for protecting the appliance to be driven against short circuits, the means for protecting including means, in each phase, for disconnecting in the event of a short circuit, with the means for switching, the means for disconnecting and the means for protecting being connected in series and being integrated in a housing.

20. The protective switching device as claimed in claim 19, wherein the means, in each phase, for disconnecting in the event of a short circuit includes a fuse in each phase, at least one fuse being removable from the housing.
